(19) United States
(12) Patent Application Publication
(10) Pub. No.: US 2020/0341472 A1
(43) Pub. Date: Oct. 29, 2020

(54) DYNAMIC VEHICLE CHARGING

(71) Applicant: Ford Global Technologies, LLC, Dearborn, MI (US)

(72) Inventors: Thomas ZENNER, Dueren, Northrhine-Westfalia (DE); Mazen HAMMOUD, Ann Arbor, MI (US); Kevin LAYDEN, Plymouth, MI (US)

(21) Appl. No.: 16/768,916

(22) PCT Filed: Dec. 7, 2017
(86) PCT No.: PCT/US2017/065088

§ 371 Date: Jun. 2, 2020

(51) Int. Cl. G05D 1/02; G01C 21/36; G06F 17/00; B60L 58/12; B25J 13/08; B60L 53/16; B60L 53/35; B60W 60/00; G05D 1/00

(52) U.S. Cl. CPC G05D 1/02; G01C 21/36; G06F 17/00; B60L 58/12; B25J 13/085; G05D 2201/0213; B60L 53/35; B60W 60/005; G05D 1/0061; B60L 2240/622; B60L 2260/40; B60L 53/16

(57) ABSTRACT

A system for receiving an electric charge from a charge-providing vehicle (CPV) and a method of using the system. A method includes: receiving, at a target vehicle, a message from a charge-providing vehicle (CPV), the message identifying a rendezvous location; operating in an autonomous follow mode at or after the location; and receiving, at a battery, an electrical charge from the CPV.

### BACKGROUND

Vehicles which have electrically-powered propulsions systems may motorize a vehicle approximately 250 minutes before requiring re-charging. Users (or persons considering a purchase of an electric vehicle) may experience so-called range anxiety—i.e., fearing that the amount of electrical charge in the vehicle may be insufficient to enable the user: to reach his/her destination, to return to a home charging station, or to reach a satellite charging station (e.g., even when the vehicle is fully-charged before departing).

### BRIEF DESCRIPTION OF THE DRAWINGS

FIG. 1 is a schematic diagram of a charge-providing vehicle (CPV) delivering electrical energy, via a robotic arm, to a charge-receiving vehicle (CRV) on a roadway.

FIG. 2 is a schematic diagram of a CPV wirelessly delivering electrical energy, via a robotic arm having a different charge port, to the CRV on the roadway.

FIG. 3 is a schematic view of a charge-receiving system of the CRV, the charge-receiving system comprising, among other things: a power management system and a computer that controls the power management system.

FIG. 4 is a schematic diagram of an example of the power management system.

FIG. 5 is a schematic diagram of an example of a power receptacle of the power management system

FIG. 6 is an example of a power receptacle that pivots, relative to a body of CRV, about at least one axis.

FIGS. 7-8 is a flow diagram illustrating a process for receiving an electrical charge from the CPV, the process being executable by a computer of the charge-receiving system.

FIG. 9 is a schematic diagram of the CRV in process of rendezvousing with the CPV to dynamically receive an electric charge within a geofence region.

### DETAILED DESCRIPTION

A charge receiving system for a charge-receiving vehicle is described. Using the system, one or more methods may be carried out. According to one example, a method comprises: receiving, at a target vehicle, a message from a charge-providing vehicle (CPV), the message identifying a rendezvous location; operating in an autonomous follow mode at or after the location; and receiving, at a battery, an electrical charge from the CPV.

According to the at least one example set forth above, the method further comprising: prior to receiving the message, transmitting a charge request to the CPV.

According to the at least one example set forth above, the request includes battery charge data.

According to the at least one example set forth above, the data comprises a battery identifier and an indication of current charge level.

According to the at least one example set forth above, the request includes current location data and route data.

According to the at least one example set forth above, the location forms part of a stretch of roadway having a threshold minimum curve radius.

According to the at least one example set forth above, the stretch corresponds with a charging duration of the battery.

According to the at least one example set forth above, the method further comprises: during the mode, receiving, at a receptacle on the target vehicle, a charge port of a robotic arm of the CPV; and moving an actuator to a locked position to retain the port.

According to the at least one example set forth above, the method further comprises: based on detecting a force, torque, or strain greater than a threshold at the receptacle, moving the actuator to an unlocked position.

According to the at least one example set forth above, a connector of the receptacle pivots about at least one axis.

According to the at least one example set forth above, the method further comprises: during the mode, receiving, via a robotic arm of the CPV, a wireless charge at the target vehicle via a receptacle comprising a wireless charging coil.

According to the at least one example set forth above, the receptacle is located on an underside of the target vehicle.

According to the at least one example set forth above, the method further comprises: prior to initiation of the mode, providing a notification to a driver within the target vehicle to handover steering control of the target vehicle to a computer.

According to the at least one example set forth above, in the mode, maintaining, within a first threshold, a spacing between the target vehicle and the CPV and maintaining, with a second threshold, a lateral alignment between the target vehicle and CPV.

According to the at least one example set forth above, the target vehicle is operating in a fully autonomous mode during and after the follow mode.

According to the at least one example set forth above, the method further comprises: prior to terminating the mode, providing a notification to a driver within the target vehicle to assume steering control of the target vehicle.

According to the at least one example set forth above, the charge is received at the battery via a direct-current fast-charging circuit.

According to the at least one example set forth above, the battery is a 400 Volt battery or an 800 Volt battery.

According to the at least one example set forth above, the rendezvous location is within a predetermined geofence region within which the CRV receives the charge.

According to at least one additional illustrative example, a system is described. The system comprises: a processor; and memory storing instructions executable by the processor, the instructions comprising, to: receive, at a target vehicle, a message from a charge-providing vehicle (CPV), the message identifying at least a portion of a geofence region; operate in an autonomous follow mode within the region; and then receive, at a battery, an electrical charge from the CPV.

According to the at least one example, a computer is disclosed that is programmed to execute any combination of the examples of the method(s) set forth above.

According to the at least one example, a computer program product is disclosed that includes a computer readable medium that stores instructions executable by a computer processor, wherein the instructions include any combination of the examples of the method(s) set forth above.

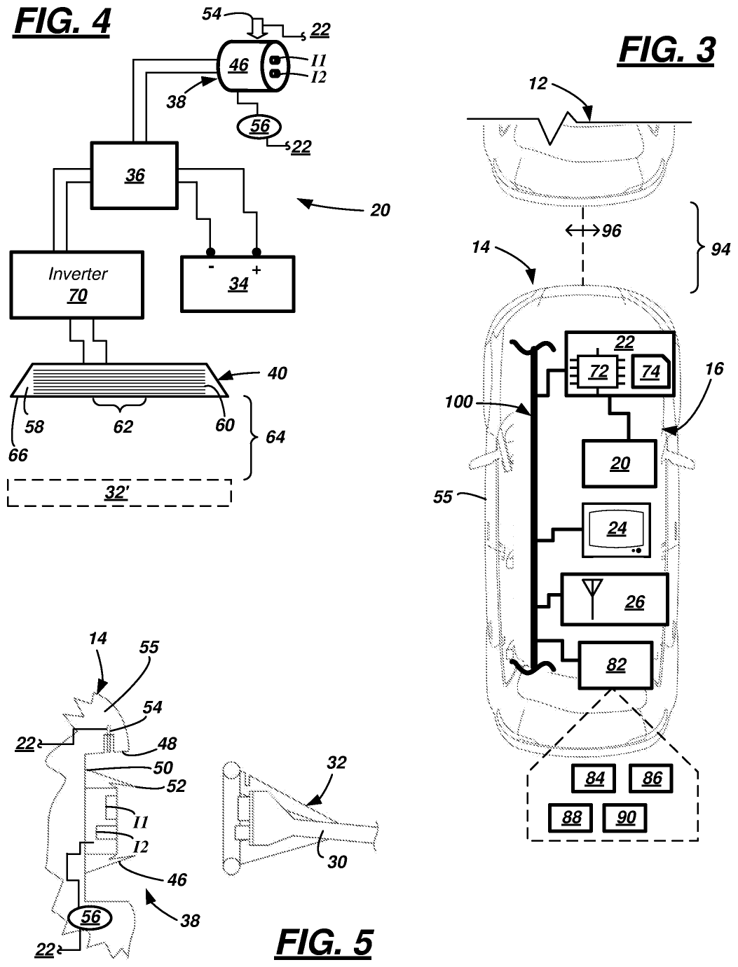

Turning now to the figures, wherein like numerals indicate like or identical components, features and/or aspects, a charge-providing vehicle (CPV) 12 is shown providing an electrical charge to a target or charge-receiving vehicle (CRV) 14. CRV 14 comprises a charge receiving system 16 that enables CRV 14 to receive a charge from CPV 12 while both vehicles 12, 14 are moving (e.g., in a dynamic mode). For example, some vehicles—e.g., which rely upon electrical energy for propulsion—may deplete their energy reserves before reaching a desired destination or before reaching a suitable charging facility. Further, CRV 14 may be able to determine—before the electrical charge is empty—that it will be unable to reach the nearest charging station. Charge receiving system 16 facilitates-in-part delivery and receipt of electrical energy (from CPV 12) to the CRV 14. According to at least one example (see FIGS. 3-4), charge receiving system 16 includes a power management system 20 configured to receive electrical charge from CPV 12, a computer 22 programmed to control at least some aspects of system 16 and execute autonomous control of vehicle 14 during stationary and/or dynamic charging events, a human-machine interface (HMI) device 24 to facilitate handover of vehicle steering, acceleration, and/or braking during charging events, and a telematics module 26 for communicating with infrastructure, other vehicles including CPVs 12, and the like. As will be explained below, CRV 14 may: send a charge request using telematics module 26; receive, via module 26, a message in response to the request indicating a rendezvous location 28 (see FIG. 9); manually or autonomously proceed to the rendezvous location 28; and, at the rendezvous location 28, enter into an autonomous follow mode permitting CPV 12 to statically or dynamically dock with CRV 14 and statically or dynamically deliver an electrical charge using power management system 20. In some instances, CRV 14 may be driven to the rendezvous location 28 by a human operator. In these instances, entering the follow mode may require a handover of vehicle steering, acceleration, and/or braking control to computer 22—and this may occur dynamically as well (i.e., vehicle 14 is not required to stop to enter the follow mode). This process may be carried out so that passengers and/or goods onboard the CRV 14 may not be delayed by the CRV 14 needing to stop and re-charge battery power (e.g., en route to its destination). Furthermore, availability of CPVs 12 may alleviate consumer range anxiety.

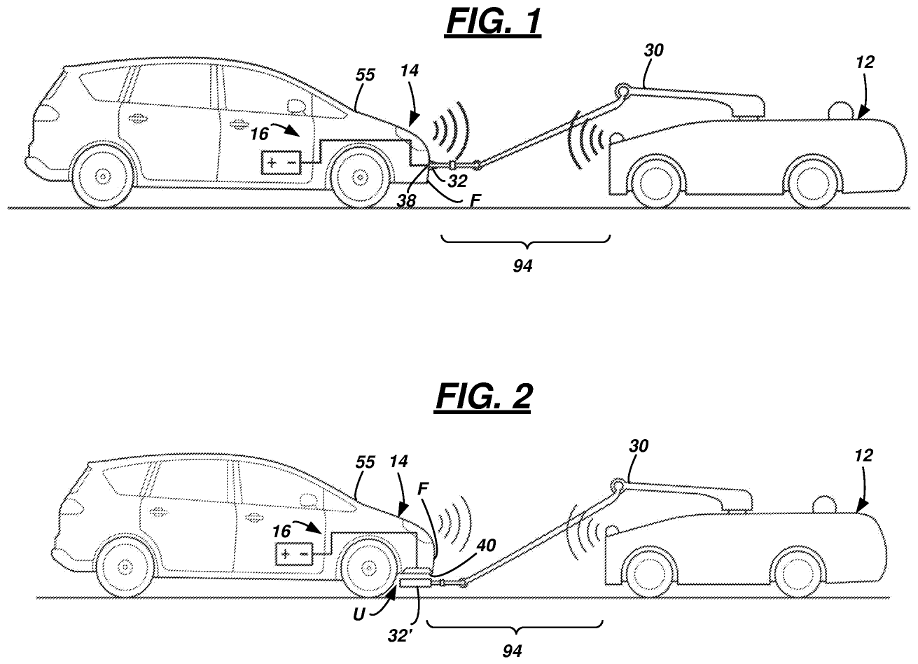

Charge-receiving vehicle (CRV) 14 may be any suitable vehicle that comprises the charge receiving system 16; e.g., it may be any vehicle adapted to store electrical charge and use at least in part the stored charge to operate the vehicle. Non-limiting examples of CRVs are battery electric vehicles (BEVs), battery-only electric vehicles (BOEVs), all-electric vehicles, or the like. FIGS. 1-2 illustrate vehicle 14 as a passenger vehicle; however, this is merely an example. Other vehicle examples include any suitable truck, sports utility vehicle (SUV), recreational vehicle, bus, or the like.

As will be described more below, computer 22 of CRV 14 may facilitate operation of the vehicle in one or more autonomous modes, as defined by the Society of Automotive Engineers (SAE) (which has defined operation at levels 0-5). More particularly, computer 22 may be store and execute logic instructions or sets of instructions embodied in hardware, software, firmware, a combination thereof, or the like thereby enabling computer 22 may operate the vehicle 14 with user assistance (partially autonomy) or without user assistance (full autonomy). For example, at levels 0-2, a human driver monitors or controls the majority of the driving tasks, often with no help from the CRV 14. For example, at level 0 (“no automation”), a human driver is responsible for all vehicle operations. At level 1 (“driver assistance”), the CRV 14 sometimes assists with steering, acceleration, or braking, but the driver is still responsible for the vast majority of the vehicle control. At level 2 (“partial automation”), the CRV 14 can control steering, acceleration, and braking under certain circumstances without human interaction. At levels 3-5, the CRV 14 assumes more driving-related tasks. At level 3 (“conditional automation”), the CRV 14 can handle steering, acceleration, and braking under certain circumstances, as well as monitoring of the driving environment. Level 3 may require the driver to intervene occasionally, however. At level 4 (“high automation”), the CRV 14 can handle the same tasks as at level 3 but without relying on the driver to intervene in certain driving modes. At level 5 (“full automation”), the CRV 14 can handle all tasks without any driver intervention. In at least one example, computer 22 of CRV 14 facilitates operation of the vehicle at level 4 and/or level 5—e.g., as the autonomous follow mode described below may be considered a level 4 or level 5 operation. Further, as discussed below, operation in one or more of the aforementioned autonomous modes may utilize a plurality of computers; therefore, computer 22 may be representative of a single computing device or multiple computing devices.

Charge-providing vehicle (CPV) 12 may be driven by a human operator, or as illustrated in FIGS. 1-2, may be operated in a fully autonomous mode (e.g., not even having a cabin for a driver). It should be appreciated that in some examples CPV 12 may navigate from CRV 12 to CRV 12—e.g., thereby providing electrical charge services to multiple vehicles. According to at least some examples, it may comprise a robotic arm 30 having a charge port 32 at a distal end thereof (FIG. 1). The robotic arm 30 may be extendable from the CPV 12 to the CRV 14, and the charge port 32 may be used to deliver electrical charge to CRV 14. FIG. 2 illustrates that in some examples, a wireless charge port 32′ may be carried by robotic arm 30 instead or in combination therewith—e.g., to provide an inductive charge to CRV 14.

Turning now to FIGS. 3-5, these figures illustrate aspects of the power management system 20. According to at least one example, system 20 comprises a battery 34 coupled to a direct-current (DC) fast-charging circuit 36 and also coupled to one or more power receptacles 38, 40. As used herein, the term battery means a single battery unit or multiple battery units or alternatively, or in combination therewith, a single storage cell for electrical energy or a plurality of such storage cells. The battery 34 may be any suitable electrical energy storage device which may be charged and discharged repeatedly while providing power to one or more vehicle systems (e.g., a powertrain system, a drivetrain system, a vehicle lighting system, etc.). Non-limiting examples of battery 34 include lead-acid type batteries, lithium-type batteries, supercapacitor-type batteries, and the like. Non-limiting examples of battery 34 include a 400V battery, an 800V battery, or the like (e.g., having a capacity of 100-200 kilo-Watt-hours (kWh) of energy).

DC fast-charging circuit 36 may be an electrical circuit configured to expedite the transfer of direct-current power from CPV 12 to CRV 14. DC fast-charging circuit 36, its circuit components (e.g., including one or more capacitive elements, etc.), its component arrangements, coupling to battery 34, and the like are known to skilled artisans. According to some examples, DC fast-charging circuit 36 may be known to deliver 80% or more of a full charge to battery 34 in less than 20 minutes. Of course, other examples exist (e.g., delivering 80-100% of a full charge in less than 30 minutes, in less than 45 minutes, in less than 60 minutes, etc.).

Power receptacle 38 may be any device adapted to receive power via live electrical contact. According to one example, receptacle 38 comprises a connector 46 having at least two terminals I1, I2 which are adapted to receive charge port 32 (of robotic arm 30). According to at least one example, connector 46 is located in a recess 48, and a base 50 of connector 46 is wider than a distal end 52 thereof such that the connector 46 tapers to end 52. In at least one example, receptacle 38 further comprises an actuator 54 that may be moved—by computer 22—between a locked position (e.g., which retains the charge port 32 in a charging position) and an unlocked position (e.g., which permits the robotic arm 30 to move the charge port 32 toward and away from the receptacle 38).

According to one example, receptacle 38 may be manufactured in accordance with ChaDemo or DCFC standards. Thus, actuator 54 may form part of connector 46 or may be exterior to connector 46 in other examples.

Receptacle 38 may be located in a front-end F of vehicle 14—e.g., on a vehicle bumper, a vehicle grill, or any portion of a vehicle body 55. In at least one example, at least a portion of receptacle 38 may pivot in at least one, two, or three axes relative to vehicle body 55. For example, FIG. 6 illustrates connector 46 pivoting in two axes (e.g., with respect to conventional vehicle axes and rotations, pitching along a y- or transverse (with respect to vehicle 14) axis and yawing about a z- or vertical (with respect to vehicle 14) axis). Regardless of whether the receptacle 38 pivots with respect to vehicle body 55, when the terminals I1, I2 are in contact with a suitable power supply (e.g., onboard CPV 12), electrical charge may be provided to the battery 34 directly or, as shown, via the DC fast-charging circuit 36.

According to at least one example (FIGS. 4-5), receptacle 38 further comprises a sensor 56 that detects a threshold force, torque, and/or strain upon receptacle 38. Sensor 56 may be a pressure sensor, a strain gauge, or any other suitable detector which may provide an electrical output to computer 22. As will be explained in greater detail below, using sensor data from the output, when computer 22 determines a force, a torque, a strain, or the like that is greater than a predetermined threshold, then computer 22 may trigger an undocking procedure (e.g., ceasing dynamic charging by CPV 12).

Alternatively, or in combination with power receptacle 38, power management system 20 may comprise wireless power receptacle 40 (see also FIG. 2). FIG. 4 illustrates an example of receptacle 40 comprising a substrate 58 carrying a wireless charging coil 60 (e.g., embedded in the substrate 58). Coil 60 may have any suitable quantity of loops, loop diameter(s), loop arrangement(s), and the like.

Receptacle 40 may be located on an underside U of vehicle 14. In at least one example, the location also is nearer the front-end F as well. In this manner, as will be explained more below, CRV 14 may follow leading CPV 12, and CPV 12 may extend robotic arm 30 (and more particularly charge port 32′) beneath a front underside U of CRV 14—e.g., locating the charge port 32′ with a threshold distance of a target region 62 of receptacle 40. According to one example, target region 62 corresponds with a center of coils 60; however, this is not required. Wireless charging may require positioning the charge port 32′ within a threshold spacing or gap 64 of a surface 66 of receptacle 40 as well. According to at least one example, the maximum gap 64 is six inches; however, this is merely an example (other examples also exist).

According to at least one example, for purposes of converting alternating and induced current to DC power, an inverter 70 may be coupled between the receptacle 40 and DC fast-charging circuit 36. According to an illustrative example, CPV 12 provides alternating current (AC) through its port 32′, and alternating current may be induced in coil 60 (without contact). And the inverter 70 then converts this AC power to DC power. Thus, inverter 70 may deliver DC power to circuit 36 which in turn provides electrical charge to battery 34.

As discussed above, power management system 20 may be coupled to and at least partially controlled by computer 22. As shown in FIG. 3, computer 22 may comprise at least one processor 72 (one is shown) and memory 74. Processor 72 may be programmed to process and/or execute digital instructions to carry out at least some of the tasks described herein. Non-limiting examples of processor 72 include a microprocessor, a microcontroller or controller, an application specific integrated circuit (ASIC), etc.—just to name a few. And a few non-limiting examples of digitally-stored instructions—storable in memory 74 and executable by processor 72—include: to determine a charge level of battery 34; to send a charge request for a recharge based on the determination; after receiving a response to the charge request, to repeatedly communicate with CPV 12 en route to a rendezvous location 28; to move to the rendezvous location 28, as instructed by CPV 12; to enter an autonomous follow mode when instructed by CPV 12; to handover control of vehicle steering, acceleration, and/or braking to computer 22 as part of entering the follow mode; to participate in a dynamic docking procedure in the follow mode (i.e., while both CPV 12 and CRV 14 are moving); to receive dynamically a wired or wireless charge from CPV 12, via its robotic arm 30 and charge port 32 (or 32′) (i.e., while both CPV 12 and CRV 14 are moving); when dynamic charging is completed, to handover control of vehicle steering, acceleration, and/or braking from computer 22 to a human driver (e.g., to exit the follow mode); and to participate in a dynamic undocking procedure, wherein (when applicable) computer 22 moves actuator 54 to an unlocked position and CPV 12 moves robotic arm 30 away from CRV 14. Additional examples of instructions which may be used instead of and/or addition these examples, as well as sequences of instructions, are described in the one or more processes below.

Memory 74 may include any non-transitory computer usable or readable medium, which may include one or more storage devices or articles. Exemplary non-transitory computer usable storage devices include conventional hard disk, solid-state memory, random access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random-access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory 74 may store one or more computer program products which may be embodied as software, firmware, or other programming instructions executable by the processor 72.

HMI device 24 (FIG. 3) may include any suitable input and/or output devices such as switches, knobs, controls, etc.—e.g., on a vehicle instrument panel, steering wheel, within a cabin of, etc. of vehicle 14—which are coupled communicatively to computer 22. In one non-limiting example, HMI device 24 may comprise an interactive touch screen or display which provides navigation information (e.g., including text, images, etc.) to the vehicle user and permits the user to enter a desired destination for the vehicle 14 in a fully autonomous mode to transport the user. In at least one example, a user of CRV 14 may request a charge via HMI device 24, may conduct a handover of vehicle control using input and/or output data at HMI device 24, and may receive a handover of vehicle control from computer 22 (exiting a follow mode) using input and/or output data at HMI device 24. It should be appreciated that an HMI device 24 and a handover procedure is not required. For example, CRV 14 may be a fully autonomous (e.g., level 5) BEV vehicle—e.g., acting as a taxi or other suitable transport. In these instances, sending a charge request, dynamic follow mode execution, and dynamic docking/undocking procedures may occur without user interaction.

Telematics module 26 may comprise any suitable telematics computing electronics configured to wirelessly communicate with other electronic devices such as remote servers, other telematics modules (e.g., onboard CPV 12), or the like. The telematics module 26 may utilize cellular technology (e.g., LTE, GSM, CDMA, and/or other cellular communication protocols), short range wireless communication technology (e.g., using Wi-Fi, Bluetooth, Bluetooth Low Energy (BLE), dedicated short range communication (DSRC), and/or other short-range wireless communication protocols), or a combination thereof. Such communication includes so-called vehicle-to-vehicle (V2V) and vehicle-to-infrastructure (V2I) communications as well—all of which will be appreciated by those skilled in the art. As will be explained in greater detail below, CRV 14 may request a charge from CPV 12 using telematics module 26 and/or HMI device 24. In response, via module 26, CRV 14 may receive information regarding a suitable rendezvous location 28 (e.g., within a geofence region 78 (see again FIG. 9)) so that CRV 14 may arrive at the rendezvous location 28 and receive a charge from CPV 12. As used herein, a rendezvous location 28 is a geographic area which is forms part of a geofence region 78; more particularly, the location 28 is near a starting point of the geofence region 78, relative to a direction of travel (or heading) of the CRV 14 and/or CPV 12 (once within the region 78). Thus, as an example, if a geofence region 78 comprises a stretch of roadway 80 (e.g., 20-50 miles in length), then the rendezvous location 28 may be within the first threshold portion of the geofence region 78 (e.g., the first 5 miles or the like). These distances are merely examples; other suitable distances may be used instead. According to at least one example, CPV 12 selects the geofence region 78 based on suitable dynamic charging conditions—e.g., being a relatively straight stretch of road (e.g., having a minimum curve radius of 450 meters), relatively constantly moving traffic (e.g., not varying average speed more than a threshold, etc.).

Returning to FIG. 3, CRV 14 also may comprise a sensor suite 82, coupled to computer 22, that comprises a number of different sensors which facilitate receiving an electrical charge from CPV 12. For example, suite 82 may comprise a position-determining unit 84 that CRV 14 may use to identify its location, the rendezvous location 28, the geofence region 78, and the like. Position-determining unit 84 may utilize geographic map data (e.g., roadway location data, intersection location data, traffic data, vehicular accident data, speed limit data, etc.) and may comprise a Global Positioning System (GPS), a Global Navigation Satellite System (GLONASS), or another similar device. Sensor suite 82 also may comprise one or more imaging devices such as a millimeter radio detection and ranging (RADAR) device 86, one or more light detection and ranging (LiDAR) devices 88, and/or one or more cameras 90. Cameras 90 may be complementary metal oxide semiconductor (CMOS) devices, charge-coupled devices (CCDs), image intensifiers, etc.). These are merely examples; other sensor types are possible as well (e.g., including vehicle speed sensors, vehicle acceleration sensors, proximity sensors (e.g., located at or near front end F of CRV 14), etc.).

Sensor data from these and other sensors may be provided to computer 22 to facilitate execution of the dynamic follow mode of CRV 14 with respect to CPV 12, to facilitate receiving a dynamic docking procedure executed by CPV 12, and the like. For example, in the follow mode, the computer 22 may control a vehicle spacing 94 (e.g., between CRV 14 and CPV 12; see FIGS. 1-2) so that it is within a threshold range and also control a vehicle alignment 96 (e.g., again between vehicles 12, 14) so that CRV 14 is centered behind CPV 12 within a threshold range. Spacing 94, alignment 96, and respective threshold ranges may be based on an extendable length of robotic arm 30 (e.g., non-limiting length examples include a length between one foot to fifteen feet).

Computer 22, HMI device 24, telematics module 26, sensor suite 82, and other electronics may be coupled to one another via a wired or wireless communication network 100. In at least one example, the connection network 100 includes one or more of a controller area network (CAN) bus, Ethernet, Local Interconnect Network (LIN), a fiber optic connection, or the like. Other examples also exist. For example, alternatively or in combination with e.g., a CAN bus, network 100 could comprise one or more discrete wired or wireless connections.

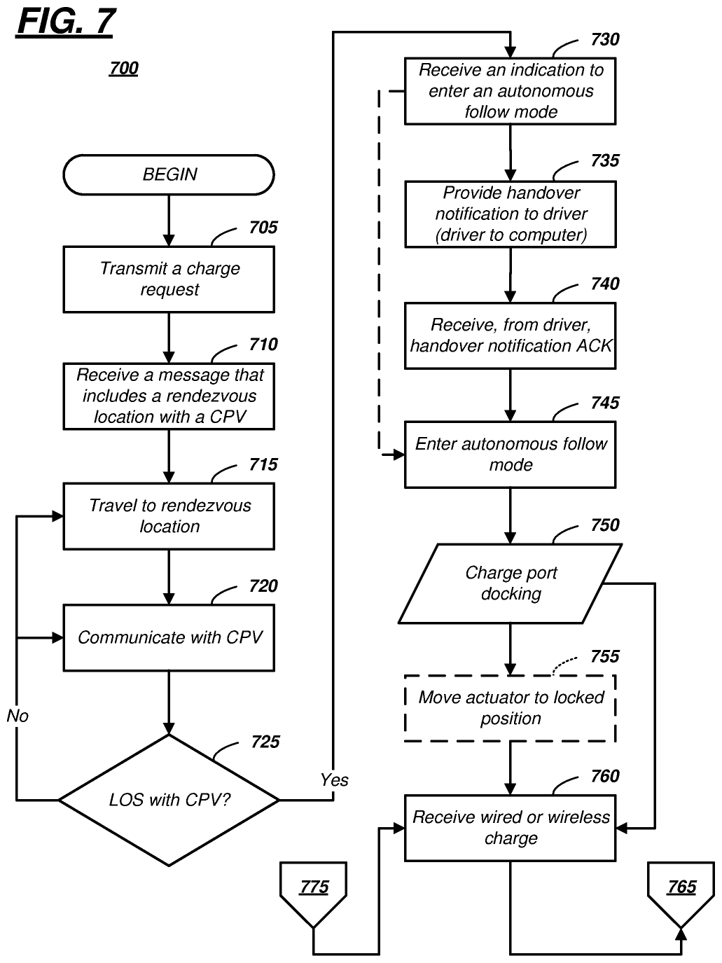

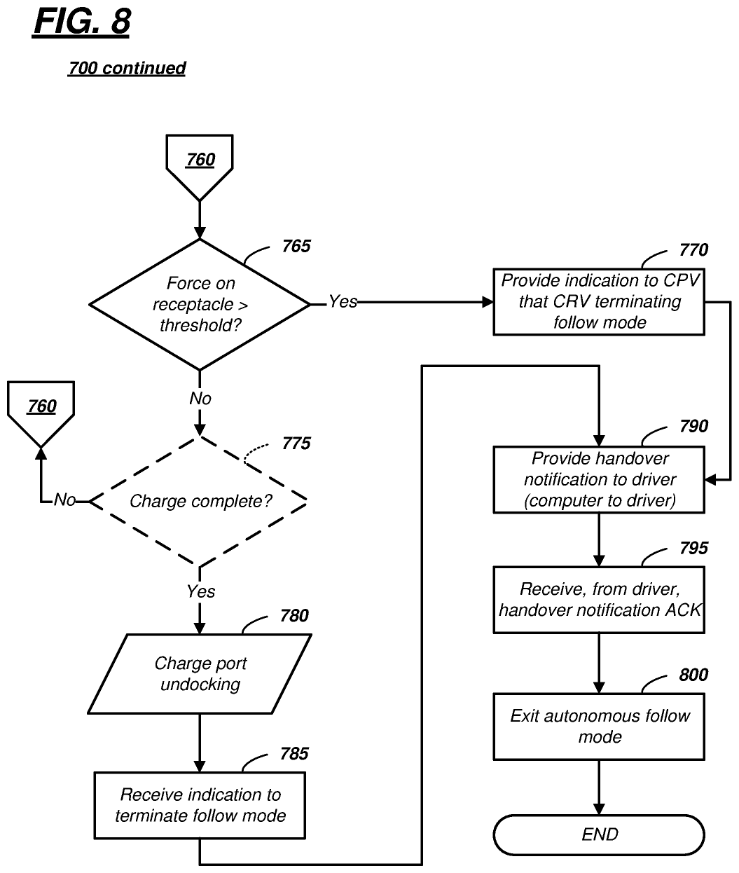

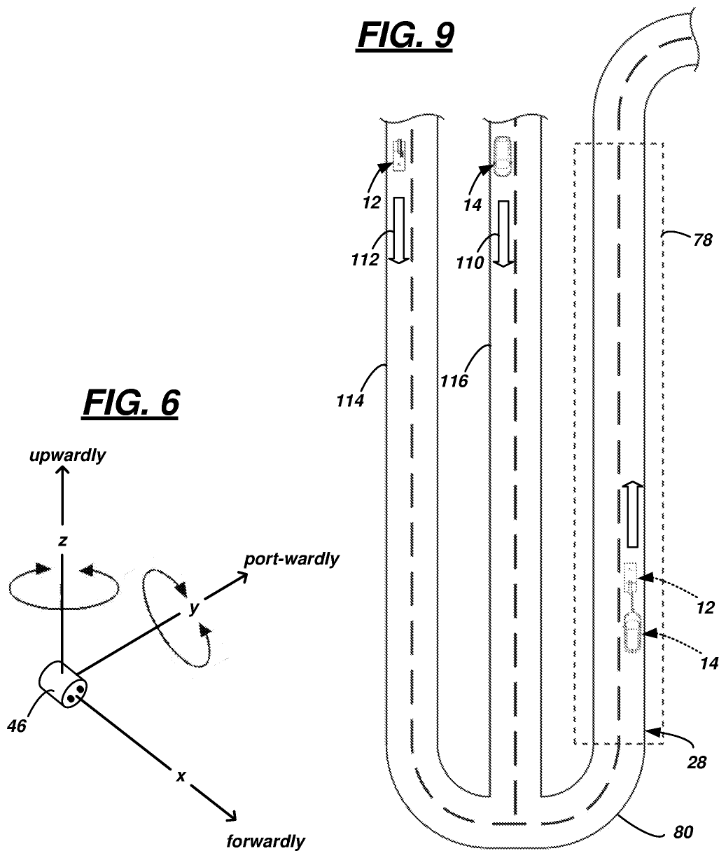

Turning now to FIGS. 7-8, the figures illustrate a flow diagram of a process 700 of receiving a dynamic electric charge at CRV 14 from a CPV 12 (e.g., including dynamic docking and dynamic undocking procedures). Other implementations may include stationary docking, stationary charging, and stationary undocking procedures. Still other implementations may comprise any suitable combination of: a dynamic docking procedure, a stationary docking procedure, a dynamic charging, a stationary charging, a dynamic undocking procedure, and a stationary undocking procedure.

Process 700 may begin with instructional or logic block 705—block 705 and other blocks described herein comprising instructions executable by computer 22. Block 705 may comprise CRV 14, via telematics module 26, transmitting a charge request to CPV 12 (or a remote server associated therewith). In some instances, this request may be transmitted via any suitable wireless communication link. In some examples, the CRV 14 transmits the request via cellular communication or via a short-range wireless communication (e.g., DSRC or the like) to CPV 12. The request may be received at CPV 12 in other ways as well (e.g., sent from a mobile device or from a web-based interface, or the like).

The request may comprise battery charge data—e.g., information that can identify to CPV 12 how, when, etc. to provide charging services to CRV 14. For example, the request may comprise an identifier of the CRV 14 (or of a mobile device, of a user, etc.), whether CRV 14 is requesting stationary charging (e.g., CPV 12 and CRV 14 parked during charging) or dynamic charging (CPV 12 and CRV 14), information regarding onboard battery 34 (e.g., a battery identifier, data defining a full-charge voltage level, data defining a present- or current-charge level, an estimated time until battery 34 is out of power, a power capacity, etc.), a type of charge receptacle 38, 40 and/or other charging interface data, a current location of CRV 14, a timestamp associated with the CRV location, a destination of CRV 14, a predicted route of CRV 14, other suitable data, or any combination thereof.

Block 710 may comprise CRV 14, via telematics module 26, receiving a message that includes a place to rendezvous with CPV 12 so that it may receive the charge. For example, in response to transmitting the charge request in block 705, CRV 14 may receive a message comprising rendezvous location 28. In at least some examples, a particular CPV 12 may determine to respond to CRV 14 based on a heading 110 of CRV 14, based on a heading 112 of the particular CPV 12, based on an ability of CPV 12 to intercept CRV 14 without CRV 14 deviating from its intended route more than a threshold, based on traffic congestion along CRV's route, etc. Accordingly, the rendezvous location 28 may be along CRV's previously predicted route (e.g., or may be a minor deviation therefrom)—e.g., so as to minimize the delay of CRV 14 reaching its intended destination.

In at least one example, block 710 further may comprise data regarding geofence region 78—e.g., wherein rendezvous location 28 is near a beginning of the geofence region 78. Again, FIG. 9 is illustrative. In this example, CPV 12 may be located on a roadway 114, and CRV 14 may be located on a roadway 116. In the example of FIG. 9, CPV 12 may determine that it and CRV 14 are going to merge onto roadway 80, and that a portion of roadway 80 comprises a suitable geofence region 78—e.g., thus, based at least in part on this information, CPV 12 may determine to rendezvous with vehicle 14 at location 28.

In some instances, the message of block 710 further may comprise information concerning a time at which CPV 12 is expected to arrive at location 28, a predicted time at which CRV 14 should arrive at the location 28, anticipated route information of CRV 14 which CPV 12 used to determine the time, and the like. In some examples, CRV 14 may confirm (to CPV 12) anticipated arrival, time, route info, etc.

In at least one example, the geofence region 78 is suitably large enough to permit CPV 12 to charge battery 34 to a desired level (e.g., before vehicles 12, 14 exit the region 78). For instance, as determined by CPV 12 (based on the battery charge data), CPV 12 may determine that battery 34 will need 30 minutes to charge, and thus CPV 12 may determine a stretch of roadway (e.g., roadway 80) having a suitable distance—based on the rate of travel—to enable the full charge to occur during that stretch. Further, to minimize complications arising from dynamic docking between CPV 12 and CRV 14, CPV 12 may determine the geofence region 78 based on the stretch of roadway 78 having a minimum radius of 450 m). Thus, CPV control of robotic arm 30 may be simplified.

In block 715, CRV 14 may navigate and travel to the rendezvous location 28. As previously stated, location 28 may be along its previously predicted route; or it may be a minor deviation therefrom. Of course, in some instances, it may be unavoidable that the deviation is more substantial (e.g., causing CRV 14 some delay)—e.g., an amount of deviation requested by CPV 12 being weighed against when CRV 14 will run out of battery power. Further, larger deviations may be based on a quantity of available CPVs 12 in the geographic area, the number of roadways available for CPV 12 to intercept vehicle 14, etc.

In block 720, CRV 14 may repeatedly communicate with CPV 12 as CRV 14 proceeds to the rendezvous location 28—e.g., as CPV 12 moves along roadway 114 according to heading 112 and while CRV 14 moves along roadway 116 via heading 110, as well as along roadway 80. In some instances, the rendezvous location 28 may be altered—e.g., to avoid delaying CRV 14.

In block 725, computer 22 (using sensor suite 82 and any other electronics or data) may determine whether it can establish line-of-sight (LOS) with CPV 12. If not, CRV 14 may continue to travel to rendezvous location 28 (looping back to block 715), continue to travel to its predetermined destination, continue to travel within the geofence region 78, and/or continue to communicate wirelessly with CPV 12 (looping back to block 720). When LOS is not established, CRV 14 may communicate to CPV 12 its geographic position, a timestamp, etc. When LOS is established, process 700 may proceed to block 730. In at least one example, computer 22 (using sensor data from suite 82) identifies CPV 12 within a line-of-sight, and process proceeds to block 730. And in at least one example, a human operator of vehicle 14 visually identifies CPV 12 and process proceeds to block 730.

Once LOS is established (and when vehicles 12, 14 are within geofence region 78), in block 730, computer 22 may receive an indication to enter an autonomous follow mode (from CPV 12). For example, CRV 14 via telematics module 26 may receive a wireless command to enter the autonomous follow mode. According to one example, CRV 14 is operating in a fully autonomous driving mode, and computer 22 instructs vehicle powertrain and steering systems to move CRV 14 behind and within a vehicle length of CPV 12. In other examples, a vehicle driver may receive an instruction via HMI device 24 to move CRV 14 into a predefined position relative to or behind CPV 12—and the driver may do so accordingly. Block 730 further may comprise computer 22, using telematics module 26, transmitting an acknowledgement (ACK) of the command

According to one example, CRV 14 may move within a threshold proximity of CPV 12, and CRV 14 being within this proximity may trigger the CPV 12 to issue the follow mode command For example, the proximity may comprise being within one or two vehicle lengths behind CPV 12 or the like.

As used herein, a follow mode is an autonomous driving mode controlled and executed by computer 22 onboard CRV 14 which enables computer 22 to assume control of steering, acceleration, and braking, wherein, in the mode, the computer 22 controls vehicle 14 movement to maintain a predetermined longitudinal spacing or gap 94 between it and the CPV 12 (e.g., within a longitudinal distance threshold) and also computer 22 controls vehicle 14 movement to maintain a predetermined lateral alignment 96 between it and the CPV 12 (e.g., also within a lateral displacement threshold (e.g., for a speed of 62 miles/hour, a max lateral jerk of

$$0.3 \frac{m}{{s}^{3}}$$

(assuming a benign jerk)). in some instances, computer 22 may execute the follow mode (at least in part) by tracking CPV 12, tracking one or more CPV features, and/or by tracking movements of CPV 12—while maintaining a maximum longitudinal distance and a maximum lateral displacement between CRV 14 and CPV 12. According to one example, the follow mode implements platoon technology, wherein computer 22 controls CRV 14 to follow CPV 12 as a platoon leader vehicle.

When vehicle 14 is properly positioned, CRV 14 may enter the follow mode (e.g., block 730 proceeding to block 745). However, in situations wherein a human operator is controlling CRV 14, process 700 first may proceed from block 730 to block 735. In block 735, computer 22 may provide a handover notification via HMI device 24—e.g., regarding handover of control from driver to computer 22. The notification explicitly may comprise that the driver will be yielding control of steering, acceleration, and/or braking to CRV computing systems.

In block 740 which follows, before entering the follow mode, computer 22 may be required to receive acknowledgement (ACK) from the driver that he/she desires to handover vehicle control. Acknowledgement may be received via one or more manual switch actuations, voice control, or the like. In at least one example, redundancy is required (e.g., at least two acknowledgement indications are required).

Following the acknowledgement(s), in block 745, CRV 14 may enter the follow mode, and, via computer 22 control, autonomously drive CRV 14 within the predetermined longitudinal range and the predetermined lateral range of CPV 12. The follow mode may permit the human driver to temporarily rest during the re-charging event.

In block 750 which follows, CRV 14 may participate in a dynamic docking procedure. For example, CPV 12 may move charge port 32 into physical contact with receptacle 38. In at least one example, computer 22 may sense the contact or may sense a voltage potential (at port 32 ) or may sense electrical power transfer using power management system 20, and in response, computer 22 may send a message to CPV 12 accordingly. It should be appreciated that when CRV 14 is in the docked position, it is not being towed (i.e., vehicle 14 is not being pulled via the robotic arm 30 of CPV 12); in fact, the robotic arm 30 may be programmed to exert little to no force on connector 46.

In other examples, block 750 could comprise detecting a proximity of charge port 32′ relative to receptacle 40—e.g., optically and/or based on detecting flux. Similarly, computer 22 may communicate (to CPV 12) port 32′ alignment with target region 62.

Optionally, in block 755 which follows, when port 32 is positioned with its terminals in contact with terminals I1, I2 computer 22 may cause actuator 54 to move from the unlocked position to the locked position—e.g., to thereby retain better electrical contact. In other port 32 examples (or in port 32′ examples), process 700 may proceed directly from block 750 to block 760.

In block 760, power management system 20 may begin to receive electrical charge via port 32 or port 32′. Current received via receptacle 38 or 40 may be processed by DC fast-charging circuit 36 and thereafter provided as charge to battery 34.

Block 765 may occur any time following block 750 (charge port docking). In block 765, computer 22 may monitor the force (and/or torque, strain, etc.) on receptacle 38. When the force, torque, strain, etc. is larger than a predetermined threshold, then process 700 may proceed to block 770 (e.g., providing an indication to CPV 12 that CRV is terminating the follow mode and actuating the actuator 54 from the locked position to the unlocked position so that port 32 may disengage contact with receptacle 38—thereby avoiding damage to receptacle 38). When the force, torque, strain, etc. is not larger than the predetermined threshold, then process 700 may proceed to block 775.

In block 775, computer 22 may determine whether the charge of battery 34 is complete. Computer 22 may determine this by measuring a voltage of battery 34, monitoring a current from CPV 12, or the like. In at least one example, total charging time may be less than 30 minutes; however, this is not required. Further, a complete charge may include charging battery 34 to something less than 100% (e.g., to 80%, to 90%, etc.), to charging battery 34 to some predetermined energy capacity (e.g., to enable vehicle 14 to reach its destination). When the charging is complete, the process proceeds to block 780, and when the process is not complete, process 700 may loop back to block 760 and repeat at least some of the aforementioned instructions.

In block 780, may participate in a dynamic undocking procedure. For example, CPV 12 may move charge port 32 out of physical contact with receptacle 38 or away from receptacle 40 while vehicles 12, 14 moving on roadway 80. In at least one example, computer 22 may send a wireless confirmation message based on visually sensed input (e.g., from sensor suite 82) that the robotic arm 30 is in its stowed position (or at least no longer extending in a manner that would be obstructive to other roadway vehicles, including being no longer obstructive to CRV 14).

In block 785 which follows, computer 22 may receive an indication to terminate the follow mode. In one instance, this indication may be based on sensor data received at computer 22 from sensor suite 82. In other examples, the indication may be a message from CPV 12. A combination of indications is also possible.

In block 790, computer 22 may initiate another handover procedure—e.g., this time from computer 22 to driver of CRV 14. Alternatively, block 790 may follow block 770, discussed above. Similar to the description above, computer 22 may provide a handover notification to the vehicle driver via HMI device 24—e.g., a handover of control from computer 22 to driver. The notification explicitly may comprise that the driver will be expected to resume control of steering, acceleration, and/or braking.

In block 795 which follows, before resuming of steering, acceleration, and/or braking, computer 22 may be required to receive acknowledgement (ACK) from the driver that he/she is prepared to receive and resume vehicle control. As before, acknowledgement may be received via one or more manual switch actuations, voice control, or the like. And again, in at least one example, redundancy may be required (e.g., two or more acknowledgements).

In block 800 which follows block 795, computer 22 may exit the autonomous follow mode. Thus, driver may assume control of vehicle 14 again—however, battery 34 may have additional electrical charge (e.g., enough charge to reach its desired destination). Where an emergency undocking occurred (e.g., as a result of undue force, torque, or strain on connector 46), then a portion of process 700 may be repeated so that vehicle 14 may receive adequate electrical charge.

Of course, in block 800, during instances wherein the CRV 14 is operating as a fully autonomous vehicle, exiting the follow mode may include maintaining computer 22 control, but not necessarily following CPV 12. Following block 800, the process may end.

It should be appreciated from the illustrative process described above, that computer 22 may be programmed with instructions that permit charging of battery 34 when its transmission is in a DRIVE mode, as well as a PARK mode. In at least one example, the electrical energy received from CPV 12 during dynamic charging may be used to power CRV electrical systems (e.g., powertrain, steering, lighting, HVAC, etc.) while excess power received from CPV 12 may be used to charge battery 34. Thus, power management system 20 may comprise a switch or other circuit so that, during charging, CRV electrical systems do not draw current from battery 34. Then, once battery 34 is desirably charged, power management system 20 may cease receiving power from CPV 12 and permit again battery 34 to power vehicle systems.

As described in part above, other examples of process 700 exist. For example, docking and/or undocking procedures may occur while the vehicles 12, 14 are stationary (e.g., in a PARK mode). In these instances (as described above), either vehicle could be operating in a fully autonomous mode or via a human operator.

In another example of process 700, CPV 12 initially may determine to execute a dynamic docking procedure; however, at the time of interception, conditions may have changed and/or CPV 12 may have received new information indicating that the electrical charge delivery should occur while vehicles 12, 14 are stationary.

Thus, there has been described a charge-receiving system for a vehicle. The charge-receiving system may include a power management system and a computer used to control the power management system and autonomous driving. According to at least one implementation, charge-receiving system is used to receive on-the-go charging of onboard batteries from a charge-providing vehicle.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, California), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor may be programmed to process the sensor data. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A method, comprising:
receiving, at a target vehicle, a message from a charge-providing vehicle (CPV), the message identifying a rendezvous location;
operating in an autonomous follow mode at or after the location; and
receiving, at a battery, an electrical charge from the CPV.

2. The method of claim 1, further comprising: prior to receiving the message, transmitting a charge request to the CPV.

3. The method of claim 2, wherein the request includes battery charge data.

4. The method of claim 3, wherein the data comprises a battery identifier and an indication of current charge level.

5. The method of claim 2, wherein the request includes current location data and route data.

6. The method of claim 1, wherein the location forms part of a stretch of roadway having a threshold minimum curve radius.

7. The method of claim 6, wherein the stretch corresponds with a charging duration of the battery.

8. The method of claim 1, further comprising: during the mode, receiving, at a receptacle on the target vehicle, a charge port of a robotic arm of the CPV;
and moving an actuator to a locked position to retain the port.

9. The method of claim 8, further comprising: based on detecting a force, torque, or strain greater than a threshold at the receptacle, moving the actuator to an unlocked position.

10. The method of claim 8, wherein a connector of the receptacle pivots about at least one axis.

11. The method of claim 1, further comprising: during the mode, receiving, via a robotic arm of the CPV, a wireless charge at the target vehicle via a receptacle comprising a wireless charging coil.

12. The method of claim 11, wherein the receptacle is located on an underside of the target vehicle.

13. The method of claim 1, further comprising: prior to initiation of the mode, providing a notification to a driver within the target vehicle to handover steering control of the target vehicle to a computer.

14. The method of claim 1, in the mode, maintaining, within a first threshold, a spacing between the target vehicle and the CPV and maintaining, with a second threshold, a lateral alignment between the target vehicle and CPV.

15. The method of claim 1, wherein the target vehicle is operating in a fully autonomous mode during and after the follow mode.

16. The method of claim 1, further comprising: prior to terminating the mode, providing a notification to a driver within the target vehicle to assume steering control of the target vehicle.

17. The method of claim 1, wherein the charge is received at the battery via a direct-current fast-charging circuit.

18. The method of claim 1, wherein the battery is a 400 Volt battery or an 800 Volt battery.

19. The method of claim 1, wherein the rendezvous location is within a predetermined geofence region within which the target vehicle receives the charge.

20. A system, comprising:
a processor; and
memory storing instructions executable by the processor, the instructions comprising, to:
receive, at a target vehicle, a message from a charge-providing vehicle (CPV), the message identifying at least a portion of a geofence region;
operate in an autonomous follow mode within the region; and then
receive, at a battery, an electrical charge from the CPV.
